(19) United States
(12) Patent Application Publication
(10) Pub. No.: US 2016/0213007 A1
(43) Pub. Date: Jul. 28, 2016

(54) Methods and Compositions to Elicit Resistance to Fungal Disease in Plants and Plant Parts

(71) Applicant: ECOFLORA AGRO S.A.S., Rionegro, Alto de las Palmas (CO)

(72) Inventors: Luis F. ECHEVERRI, Medellin (CO); James A JIMENEZ, Medellin (CO); Luis F. TORRES, Medellin (CO)

(73) Assignee: ECOFLORA AFRO S.A.S.

(21) Appl. No.: 14/916,866

(22) PCT Filed: Sep. 5, 2014
(86) PCT No.: PCT/IB2014/002644

§ 371 Date: Mar. 4, 2016

Related U.S. Application Data
(60) Provisional application No. 61/874,141, filed on Sep. 5, 2013.

(51) Int. Cl. A01N 65/28; A01N 43/90

(52) U.S. Cl. CPC A01N 65/28; A01N 43/90

(57) ABSTRACT

The present invention relates to a method to elicit resistance in a living plant or in a harvested plant part to a disease caused by fungal pathogens, wherein the method comprises exposing a plant or a plant part to an essential oil vapor containing cineole. The present invention also relates to a package for a plant or a plant part containing essential oil comprising cineole, wherein the essential oil turns into a vapor form within the package and further to a composition comprising a solution or an atomized spray containing an essential oil.

### BACKGROUND OF THE INVENTION

1. Field of the Invention

The present invention provides a method to elicit resistance in a plant to disease by fungal infection, wherein the method comprises exposing at least one plant to an essential oil vapor, and wherein the essential oil contains cineole. The present invention also provides a plant package in combination with an essential oil containing cineole for eliciting resistance in the plant to disease by fungal infection, wherein the plant is susceptible to infection by a fungus, wherein the essential oil turns into a vapor form in the environment surrounding the plant. The present invention also provides a composition to elicit resistance in a plant to disease by fungal infection, wherein the composition comprises a solution or an atomized spray, and wherein the solution or the atomized spray comprises an essential oil in combination with 2-hydroxy acetophenone or a derivative of acetophenone.

2. Background Art

Tomato fruit decay after harvest is a prevalent problem that causes significant economic losses. Tomato fruit decay is mainly caused by fungus, e.g., Botrytis cinerea, Rhizopus stolonifer, Alternaria alternate, Colletotrichum coccodes, etc. Usually, tomato fruit decay may be prevented by applying an antifungal agent (e.g., pesticides or natural agents) directly to the fruits.

The application of antifungal agents to fruits has several disadvantages. In the case of pesticides, their use is limited because of toxicity which may require complicated formulations such as applying a pesticide in a wax layer. See Hall, D. J., “Post Harvest Treatment of Florida Fresh Market Tomatoes with Fungicidal Wax to Reduce Decay,” Proc. Fla. State Hort. Soc. 102:365-367 (1989).

Natural agents are an alternative to the use of pesticides. However, the antifungal effect of natural agents may require application of high doses, as is the case for essential oils. For example, to avoid application of high doses of essential oils to prevent tomato decay, antagonists to decay causing pathogens have been combined with a low dose of an essential oil. See Abd-Alla, M. A., et al., “Formulation of Essential Oils and Yeast for Controlling Postharvest Decay of Tomato Fruits,” Plant Pathology Bulletin 18:23-33 (2009).

Tzortzakis, N. G., “Maintaining postharvest quality of fresh produce with volatile compounds,” Innovative Food Science & Emerging Technologies 8:111-116 (2007) describes a study evaluating the postharvest quality of strawberry and tomato fruit after treatment with eucalyptus and cinnamon volatile oil compounds. Tripathi, P., et al., “Use of some essential oils as post-harvest botanical fungicides in the management of grey mould of grapes caused by Botrytis cinerea,” World J. Microbiol. Biotechnol. 24:39-46 (2008) describes a screen of twenty six essential oils against Botrytis cinerea that were found to exhibit absolute fungitoxic activity (100% growth inhibition).

In the case of antifungal agents, the antifungal has to be applied to the tomato directly. The present invention overcomes the need to apply an antifungal agent to a plant directly. Instead, by means of the present invention, fruit resistance to decay causing pathogens is elicited.

### BRIEF SUMMARY OF THE INVENTION

The present invention provides a method to elicit resistance in a plant to disease by fungal infection, wherein the method comprises exposing at least one plant to an essential oil vapor, and wherein the essential oil contains cineole.

The present invention also provides a plant package in combination with an essential oil containing cineole for eliciting resistance in the plant to disease by fungal infection, wherein the plant is susceptible to infection by a fungus, wherein the essential oil turns into a vapor form in the environment surrounding the plant.

The present invention also provides a composition to elicit resistance in a plant to disease by fungal infection, wherein the composition comprises a solution or an atomized spray, and wherein the solution or the atomized spray comprises an essential oil in combination with 2-hydroxy acetophenone or a derivative of acetophenone.

In some embodiments, the concentration of the vapor derived from the essential oil is between about 1 ppm and about 1000 ppm. In some embodiments, the concentration of the vapor derived from the essential oil is between about 5 ppm and about 750 ppm. In some embodiments, the vapor derived from the essential oil is between about 100 ppm and about 600 ppm.

In some embodiments, the concentration of the solution or the atomized spray is between about 1 ppm and about 1000 ppm. In some embodiments, the concentration of the solution or the atomized spray is between about 5 ppm and about 750 ppm. In some embodiments, the concentration of the solution or the atomized spray is between about 100 ppm and about 600 ppm.

In some embodiments, the essential oil is eucalyptus oil.

In some embodiments, the fungus is selected from the group consisting of Botryotinia, Streptomyces, and Penicillium. In some embodiments, the fungus is from the species Botrytis cinerea.

In some embodiments, the plant is selected from the group consisting of a potato, a tomato, an aubergine, a chili pepper, a bell pepper, a tomatillo, a groundcherry, a cape gooseberry, a tobacco, an apple, a pear, a quince, a peach, a plum, a cherry, a strawberry, a grape, an almond, an apricot, a blackberry, a raspberry, a rose, a petunia, a browallia, or a lycianthes. In some embodiments, the plant is selected from the group consisting of a tomato, a strawberry, and a pear. In some embodiments, the plant is a tomato. In some embodiments, the plant is a strawberry. In some embodiments, the plant is a pear.

In some embodiments, less than about 50% of total antibiotic activity on the fungus derives from a direct fungitoxic effect of the essential oil or the essential oil vapor on the fungus. In some embodiments, less than about 30% of total antibiotic activity on the fungus derives from a direct fungitoxic effect of the essential oil or the essential oil vapor on the fungus. In some embodiments, less than about 15% of total antibiotic activity on the fungus derives from direct fungitoxic effect of the essential oil or the essential oil vapor on the fungus.

In some embodiments, the plant package is selected from the group consisting of a potato, a tomato, an aubergine, a chili pepper, a bell pepper, a tomatillo, a groundcherry, a cape gooseberry, a tobacco, an apple, a pear, a quince, a peach, a plum, a cherry, a strawberry, a grape, an almond, an apricot, a blackberry, a raspberry, a rose, a petunia, a browallia, or a lycianthes. In some embodiments, the plant package is selected from the group consisting of a tomato, a strawberry, and a pear. In some embodiments, the plant package is a tomato. In some embodiments, the plant package is a strawberry. In some embodiments, the plant package is a pear.

### BRIEF DESCRIPTION OF THE DRAWINGS

FIG. 1 is a photograph of a test container used to evaluate pears infected with Botrytis cinerea. The container contains 8 pears, a Petri dish half containing a sponge, a 2 ounce condiment cup filled with tap water, a metal screen, and wooden blocks for support.

FIG. 2 is a photograph of pears at day 6 and day 12 which were treated with (A) Botrytis cinerea spores and 0.25 mL eucalyptus oil, (B) Botrytis cinerea spores and 0.50 mL eucalyptus oil, (C) Botrytis cinerea spores and 1.0 mL eucalyptus oil, (D) with neither Botrytis cinerea spores nor eucalyptus oil, and (E) with Botrytis cinerea spores but no eucalyptus oil.

FIG. 3 is a bar chart comparing the percentage of healthy strawberries four days after Botrytis cinerea infection followed by treatment with 0.25 mL of eucalyptus oil (exposure time of 6, 12, or 24 hours), treatment with 1.0 mL of eucalyptus oil (exposure time of 6, 12, or 24 hours), or no treatment. Also shown is the percentage of healthy strawberries after 4 days that were not infected with Botrytis cinerea.

FIG. 4 are photographs of (A) strawberries four days after infection with Botrytis cinerea followed by treatment with 0.25 mL of eucalyptus oil (exposure time of 24 hours) and (B) strawberries four days after infection with with Botrytis cinerea followed by treatment with 1.0 mL of eucalyptus oil (exposure time of 24 hours).

FIG. 5 is a bar chart comparing the percentage of healthy strawberries at 3, 6, 9, 12, and 15 days (bars from left to right) stored at 4° C. after Botrytis cinerea infection followed by treatment with 0.25 mL of eucalyptus oil, treatment with 0.50 mL of eucalyptus oil, treatment with 1.0 mL of eucalyptus oil, and with no treatment. Also shown is the percentage of healthy strawberries after 3, 6, 9, 12, and 15 days stored at 4° C. that were not infected with Botrytis cinerea.

FIG. 6 is a bar chart comparing the percentage of healthy strawberries at 3 and 6 days stored at 25° C. after Botrytis cinerea infection followed by treatment with 0.25 mL of eucalyptus oil, treatment with 0.50 mL of eucalyptus oil, treatment with 1.0 mL of eucalyptus oil, and with no treatment. Also shown is the percentage of healthy strawberries after 3 and 6 days stored at 25° C. that were not infected with Botrytis cinerea.

### DETAILED DESCRIPTION OF THE INVENTION

As used herein, the singular terms “a” and “the” are synonymous and used interchangeably with “one or more” and “at least one,” unless the language and/or context clearly indicates otherwise. As used herein, the term “comprising” means including, made up of, and composed of. All numbers in this description indicating amounts, ratios of materials, physical properties of materials, and/or use are to be understood as modified by the word “about,” except as otherwise explicitly indicated.

The term “about” as used herein includes the recited number±10%. Thus, “about ten” means 9 to 11.

The phrase “to elicit resistance in a plant to disease by fungal infection” as used herein means that a plant, exposed to an essential oil containing 1,8-cineole, becomes less susceptible to decay when the plant is exposed to a fungus, wherein the essential oil or the essential oil vapor does not have a direct fungitoxic effect.

The term “fungitoxic effect” as used herein refers to a deleterious effect exerted on a fungi.

The term “essential oil” as used herein refers to a class of volatile, odiferous oils of vegetable origin that give plants their characteristic odors, that are obtained from various parts of the plants, for example, by steam distillation, expression, or extraction, that are usually mixtures of compounds.

The term “essential oil vapor” as used herein defines the gaseous state of the essential oil, wherein said essential oil gaseous state occurs because of transformation from the essential oil liquid state due to the volatile nature of essential oil.

The term “plant” as used herein refers to a living organism exemplified by trees, shrubs, grasses, ferns, vegetables, and fruits. In some embodiments, the plant is a fruit, a vegetable, a grain, a nut, or an ornamental.

The term “package” as used herein refers to any type of container, box, carton, bag, or bin that can be filled with plants. A package is designed to contain a relatively large quantity of plants.

1,8-cineole is a natural organic compound that is a colorless liquid. 1,8-cineole is also known as eucalyptol or cineole. In some embodiments, the essential oil contains 1,8-cineole. In some embodiments, the concentration of 1,8-cineole in the essential oil is from 30% to 99.9%, 30% to 99.8%, 30% to 99.7%, 30% to 99.6%, 30% to 99%, 30% to 95%, 30% to 90%, 30% to 80%, 30% to 70%, 30% to 60%, 30% to 50%, 30% to 40%, 40% to 99.9%, 40% to 99.8%, 40% to 99.7%, 40% to 99.6%, 40% to 99%, 40% to 95%, 40% to 90%, 40% to 80%, 40% to 70%, 40% to 60%, 40% to 50%, 50% to 99.9%, 50% to 99.8%, 50% to 99.7%, 50% to 99.6%, 50% to 99%, 50% to 95%, 50% to 90%, 50% to 80%, 50% to 70%, 50% to 60%, 60% to 99.9%, 60% to 99.8%, 60% to 99.7%, 60% to 99.6%, 60% to 99%, 60% to 95%, 60% to 90%, 60% to 80%, 60% to 70%, 70% to 99.9%, 70% to 99.8%, 70% to 99.7%, 70% to 99.6%, 70% to 99%, 70% to 95%, 70% to 90%, 70% to 80%, 80% to 99.9%, 80% to 99.8%, 80% to 99.7%, 80% to 99.6%, 80% to 99%, 80% to 95%, 80% to 90%, 90% to 99.9%, 90% to 99.8%, 90% to 99.7%, 90% to 99.6%, 90% to 99%, 90% to 95%, 95% to 99.9%, 95% to 99.8%, 95% to 99.7%, 95% to 99.6%, 95% to 99%, 99% to 99.9%, 99% to 99.8%, 99% to 99.7%, 99% to 99.6%, 99% to 99.5%, 99.5% to 99.9%, 99.5% to 99.8%, 99.5% to 99.7%, 99.5% to 99.6%, 99.6% to 99.9%, 99.6% to 99.8%, 99.6% to 99.7%, 99.7% to 99.9%, 99.7% to 99.8%, or 99.8% to 99.9%. In some embodiments, the concentration of 1,8-cineole in the essential oil is about 80%. In some embodiments, the concentration of the 1,8-cineole in the essential oil is greater than 99%. An essential oil (Eucalyptol) which contains greater than 99% 1,8-cineole can be obtained from Sigma Aldrich, St. Louis, Mo. In some embodiments, the concentration of the 1,8-cineole in the essential oil is 75%. Eucalyptus oil which contains 75% 1,8-cineole can be obtained from Industrias Quimicas FIQ, Bogota, Colombia.

Eucalyptus oil is a generic collective name for oils from the Eucalyptus genus. 1,8-cineole comprises up to 90% of the essential oil in some species of the generic product Eucalyptus oil. In some embodiments, the essential oil is eucalyptus oil.

1,8-cineole can be found in the plants Amomum costatum (black cardamom), Amomum subulatum (black cardamom), Amomum xanthioides (black cardamom seed), Cinnamomum caphora (camphor laurel), Elettaria cardamomum (green cardamom), Elettaria repens (Ceylon cardamom), Eucalyptus cneorifolia, Eucalyptus dives, Eucalyptus dumosa, Eucalyptus globulus, Eucalyptus goniocalyx, Eucalyptus horistes, Eucalyptus kochii, Eucalyptus leucoxylon, Eucalyptus oleosa, Eucalyptus polybractea, Eucalyptus radiata, Eucalyptus staigeriana, Eucalyptus sideroxylon, Eucalyptus smithii, Eucalyptus tereticornis, Eucalyptus viridis, Helichrysum gymnocephalum, Turnera diffusa, Zingiber officinale, Kaempferia galanga (galangal), Laurus nobilis (bay laurel), Melaleuca alternifolia (tea tree), and Umbellularia californica (pepperwood). In some embodiments, the 1,8-cineole is from the plant Eucalyptus globulus.

In some embodiments, the essential oil is purified prior to administration. In some embodiments, the essential oil is purified by distillation. In some embodiments, the essential oil is used without purification.

In some embodiments, the essential oil is administered, for example, by low pressure spraying, high pressure spraying, brushing, misting, vaporizing, volatilizing, fogging, fumigating, immersing, injecting, vapor treating, pressure treating, drenching, drip irrigating, atomizing, broadcasting, or foaming. In some embodiments, the essential oil is administered, for example, using an emulsion, a solution, a concentrate, a cover, a vapor, a capsule, or a microcapsule. In some embodiments, the essential oil is administered, for example, using a fogger, a sprayer, a diffusor, a box, an envelope, a paper, a tunnel, a postharvest room, a container, a cooling room, or a refrigerator. In some embodiments, the essential oil is administered by vaporizing. In some embodiments, the essential oil is administered as a solution. In some embodiments, the essential oil is administered as an atomized spray.

In some embodiments, the essential oil or a composition comprising the essential oil is administered as a solution or a spray. In some embodiments, the solution or the spray further comprises a solvent. In some embodiments, the solvent is, for example, methanol, ethanol, isopropanol, methyl acetate, ethyl acetate, isopropyl acetate, n-butyl acetate, isobutyl acetate, acetone, methyl ethyl ketone, methyl isobutyl ketone, dibutyl ether, anisole, toluene, heptane, supercritical CO₂, or mixtures thereof. In some embodiments, the solvent is water.

In some embodiments, the essential oil is administered in the form of a vapor. In some embodiments, the concentration of the vapor derived from the essential oil is between 0.5 ppm and 1500 ppm, 0.5 ppm and 1000 ppm, 0.5 ppm and 750 ppm, 0.5 ppm and 600 ppm, 0.5 ppm and 500 ppm, 0.5 ppm and 400 ppm, 0.5 ppm and 300 ppm, 0.5 ppm and 200 ppm, 0.5 ppm and 100 ppm, 0.5 ppm and 50 ppm, 0.5 ppm and 10 ppm, 0.5 ppm and 5 ppm, 0.5 ppm and 1 ppm, 1 ppm and 1500 ppm, 1 ppm and 1000 ppm, 1 ppm and 750 ppm, 1 ppm and 600 ppm, 1 ppm and 500 ppm, 1 ppm and 400 ppm, 1 ppm and 300 ppm, 1 ppm and 200 ppm, 1 ppm and 100 ppm, 1 ppm and 50 ppm, 1 ppm and 10 ppm, 1 ppm and 5 ppm, 5 ppm and 1500 ppm, 5 ppm and 1000 ppm, 5 ppm and 750 ppm, 5 ppm and 600 ppm, 5 ppm and 500 ppm, 5 ppm and 400 ppm, 5 ppm and 300 ppm, 5 ppm and 200 ppm, 5 ppm and 100 ppm, 5 ppm and 50 ppm, 5 ppm and 10 ppm, 10 ppm and 1500 ppm, 10 ppm and 1000 ppm, 10 ppm and 750 ppm, 10 ppm and 600 ppm, 10 ppm and 500 ppm, 10 ppm and 400 ppm, 10 ppm and 300 ppm, 10 ppm and 200 ppm, 10 ppm and 100 ppm, 10 ppm and 50 ppm, 50 ppm and 1500 ppm, 50 ppm and 1000 ppm, 50 ppm and 750 ppm, 50 ppm and 600 ppm, 50 ppm and 500 ppm, 50 ppm and 400 ppm, 50 ppm and 300 ppm, 50 ppm and 200 ppm, 50 ppm and 100 ppm, 100 ppm and 1500 ppm, 100 ppm and 1000 ppm, 100 ppm and 750 ppm, 100 ppm and 600 ppm, 100 ppm and 500 ppm, 100 ppm and 400 ppm, 100 ppm and 300 ppm, 100 ppm and 200 ppm, 200 ppm and 1500 ppm, 200 ppm and 1000 ppm, 200 ppm and 750 ppm, 200 ppm and 600 ppm, 200 ppm and 500 ppm, 200 ppm and 400 ppm, 200 ppm and 300 ppm, 300 ppm and 1500 ppm, 300 ppm and 1000 ppm, 300 ppm and 750 ppm, 300 ppm and 600 ppm, 300 ppm and 500 ppm, 300 ppm and 400 ppm, 400 ppm and 1500 ppm, 400 ppm and 1000 ppm, 400 ppm and 750 ppm, 400 ppm and 600 ppm, 400 ppm and 500 ppm, 500 ppm and 1500 ppm, 500 ppm and 1000 ppm, 500 ppm and 750 ppm, 500 ppm and 600 ppm, 600 ppm and 1500 ppm, 600 ppm and 1000 ppm, 600 ppm and 750 ppm, 750 ppm and 1500 ppm, 750 ppm and 1000 ppm, or 1000 ppm and 1500 ppm. In some embodiments, the concentration of the vapor derived from the essential oil is between 1 ppm and 1000 ppm. In some embodiments, the concentration of the vapor derived from the essential oil is between 5 ppm and 750 ppm. In some embodiments, the concentration of the vapor derived from the essential oil is between 100 ppm and 600 ppm. In some embodiments, the concentration of the vapor derived from the essential oil is 500 ppm.

In some embodiments, the concentration of the solution or the atomized spray comprising an essential oil is between 0.5 ppm and 1500 ppm, 0.5 ppm and 1000 ppm, 0.5 ppm and 750 ppm, 0.5 ppm and 600 ppm, 0.5 ppm and 500 ppm, 0.5 ppm and 400 ppm, 0.5 ppm and 300 ppm, 0.5 ppm and 200 ppm, 0.5 ppm and 100 ppm, 0.5 ppm and 50 ppm, 0.5 ppm and 10 ppm, 0.5 ppm and 5 ppm, 0.5 ppm and 1 ppm, 1 ppm and 1500 ppm, 1 ppm and 1000 ppm, 1 ppm and 750 ppm, 1 ppm and 600 ppm, 1 ppm and 500 ppm, 1 ppm and 400 ppm, 1 ppm and 300 ppm, 1 ppm and 200 ppm, 1 ppm and 100 ppm, 1 ppm and 50 ppm, 1 ppm and 10 ppm, 1 ppm and 5 ppm, 5 ppm and 1500 ppm, 5 ppm and 1000 ppm, 5 ppm and 750 ppm, 5 ppm and 600 ppm, 5 ppm and 500 ppm, 5 ppm and 400 ppm, 5 ppm and 300 ppm, 5 ppm and 200 ppm, 5 ppm and 100 ppm, 5 ppm and 50 ppm, 5 ppm and 10 ppm, 10 ppm and 1500 ppm, 10 ppm and 1000 ppm, 10 ppm and 750 ppm, 10 ppm and 600 ppm, 10 ppm and 500 ppm, 10 ppm and 400 ppm, 10 ppm and 300 ppm, 10 ppm and 200 ppm, 10 ppm and 100 ppm, 10 ppm and 50 ppm, 50 ppm and 1500 ppm, 50 ppm and 1000 ppm, 50 ppm and 750 ppm, 50 ppm and 600 ppm, 50 ppm and 500 ppm, 50 ppm and 400 ppm, 50 ppm and 300 ppm, 50 ppm and 200 ppm, 50 ppm and 100 ppm, 100 ppm and 1500 ppm, 100 ppm and 1000 ppm, 100 ppm and 750 ppm, 100 ppm and 600 ppm, 100 ppm and 500 ppm, 100 ppm and 400 ppm, 100 ppm and 300 ppm, 100 ppm and 200 ppm, 200 ppm and 1500 ppm, 200 ppm and 1000 ppm, 200 ppm and 750 ppm, 200 ppm and 600 ppm, 200 ppm and 500 ppm, 200 ppm and 400 ppm, 200 ppm and 300 ppm, 300 ppm and 1500 ppm, 300 ppm and 1000 ppm, 300 ppm and 750 ppm, 300 ppm and 600 ppm, 300 ppm and 500 ppm, 300 ppm and 400 ppm, 400 ppm and 1500 ppm, 400 ppm and 1000 ppm, 400 ppm and 750 ppm, 400 ppm and 600 ppm, 400 ppm and 500 ppm, 500 ppm and 1500 ppm, 500 ppm and 1000 ppm, 500 ppm and 750 ppm, 500 ppm and 600 ppm, 600 ppm and 1500 ppm, 600 ppm and 1000 ppm, 600 ppm and 750 ppm, 750 ppm and 1500 ppm, 750 ppm and 1000 ppm, or 1000 ppm and 1500 ppm. In some embodiments, the concentration of the solution or the atomized spray between 1 ppm and 1000 ppm. In some embodiments, the concentration of the solution or the atomized spray is between 5 ppm and 750 ppm. In some embodiments, the concentration of the solution or the atomized spray is between 100 ppm and 600 ppm. In some embodiments, the concentration of the solution or the atomized spray is 500 ppm.

In some embodiments, the essential oil is applied for 5 minutes, 10 minutes, 20 minutes, 30 minutes, 40 minutes, 50 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 1 day, 2 days, 3 days, 4 days, 5 days, 6 days, or 7 days.

In some embodiments, the essential oil is applied to one or more plants. In some embodiments, the essential oil is applied to a package of plants. In some embodiments, the plant is a fruit, a vegetable, a grain, a nut, or an ornamental. In some embodiments, the plant is selected from the group consisting of a potato, a tomato, an aubergine, a chili pepper, a bell pepper, a tomatillo, a groundcherry, a cape gooseberry, a tobacco, an apple, a pear, a quince, a peach, a plum, a cherry, a strawberry, a grape, an almond, an apricot, a blackberry, a raspberry, a rose, a petunia, a browallia, or a lycianthes.

In some embodiments, the plant is a fruit. In some embodiments, the essential oil is applied to one or more fruits. In some embodiments, the essential oil is applied to a package of fruit. In some embodiments, the fruit is an apple, an apricot, an avocado, a banana, a breadfruit, a bilberry, a blackberry, a blackcurrant, a blueberry, a boysenberry, a currant, a cherry, a cherimoya, a chili, a cloudberry, a coconut, a damson, a date, a dragonfruit, a durian, an elderberry, a feijoa, a fig, a gooseberry, a grape, a grapefruit, a guava, a huckleberry, a jackfruit, a jettamelon, a jambul, a jujube, a kiwi fruit, a kumquat, a lemon, a lime, a loquat, a lychee, a mango, a melon, a canary melon, a cantaloupe, a honeydew, a watermelon, a rock melon, a nectarine, a nut, an orange, a clementine, a mandarine, a tangerine, a papaya, a peach, a pepper, a pear, a persimmon, a tomatillo, a plum, a pineapple, a pomegranate, a pomelo, a mangosteen, a quince, a raspberry, a rambutan, a redcurrant, a salal berry, a satsuma, a star fruit, a strawberry, a tamarillo, a tomato, or an ugli fruit. In some embodiments, the essential oil is applied to a tomato, a pear, or a strawberry. In some embodiments, the essential oil is applied to a tomato. In some embodiments, the essential oil is applied to a pear. In some embodiments, the essential oil is applied to a strawberry.

In some embodiments, the plant is a vegetable. In some embodiments, the essential oil is applied to one or more vegetables. In some embodiments, the essential oil is applied to a package of vegetables. In some embodiments, the vegetable is an artichoke, an arugula, an asparagus, an eggplant (aubergine), an avocado, an amaranth, an alfalfa sprout, an azuki bean, a bean sprout, a black bean, a black-eyed pea, a borlotti bean, a chickpea, a green bean, a kidney bean, a lentil, a lima bean, a mung bean, a navy bean, a pinto bean, a runner bean, a soy bean, a pea, a bok Choy, a breadfruit, a broccoflower, a broccoli, a brussel sprout, a cabbage, a calabrese, a carrot, a cauliflower, a celery, a chard, a collard green, a corn, an endive, a fiddlehead, a frisee, an anise, a basil, a coriander, a chamomile, a dill, a fennel, a lavender, a lemon grass, a marjoram, an oregano, a parsley, a rosemary, a sage, a thyme, a kale, a kohlrabi, a lettuce, a mushroom, a mustard green, a nettle, a spinach, an okra, a chive, a garlic, a leek, an onion, a shallot, a scallion, a bell pepper, a green pepper, a chili pepper, a jalapeno pepper, a habanero pepper, a paprika pepper, a tabasco pepper, a cayenne pepper, a radicchio, a rhubarb, a beetroot, a celeriac, a daikon, a ginger, a parsnip, a rutabaga, a turnip, a radish, a horseradish, a salsify, a skirret, an artichoke, a topinambur, an acorn squash, a butternut squash, a banana squash, a zucchini, a cucumber, a delicata, a gem squash, a hubbard squash, a pumpkin, a spaghetti squash, a tat soi, a jicama, a Jerusalem artichoke, a potato, a sweet potato, a taro, a yam, a water chestnut, or a watercress.

In some embodiments, the plant is a grain. In some embodiments, the essential oil is applied to one or more grains. In some embodiments, the essential oil is applied to a package of grain. In some embodiments, the grain is amaranth, barley, hulled barley, Scotch barley, pearl barley, barley flakes, barley grits, buckwheat, buckwheat groats, roasted buckwheat, buckwheat grits, corn, hominy, popcorn, millet, oats, oat groats, rolled oats, steel cut oats, quick cooking oats, instant oats, oat bran, quinoa, rice, rye, rye berries, cracked rye, rye flakes, sorghum, spelt, spelt berries, spelt flakes, teff, triticale, triticale berries, triticale flakes, wheat, wheat berries, bulgur wheat, cracked wheat, farina, semolina, wheat bran, wheat flakes, or wild rice.

In some embodiments, the plant is a nut. In some embodiments, the essential oil is applied to one or more nuts. In some embodiments, the essential oil is applied to a package of nuts. In some embodiments, the nut is an acorn, an almond, a Brazil nut, a candlenut, a cashew, a chestnut, a coconut, a hazelnut, a filbert, a kola nut, a macadamia nut, a peanut, a pecan, a pili nut, a pine nut, a pistachio nut, a soynut, a walnut, a black walnut, a butternut, or a heartnut.

In some embodiments, the plant is an ornamental. In some embodiments, the essential oil is applied to one or more ornamentals. In some embodiments, the essential oil is applied to a package of ornamentals. In some embodiments, the ornamental is an acacia, an African iris, an African violet, a agapanthus, an ageratum, an ajuga, an Algerian ivy, an allamanda, an allium, an alyssum, an amaryllis, an American arborvitae, an American dogwood, an American holly, an American plane tree, an angelwing jasmine, an anthurium, an areca palm, an Arizona cypress, an arum lily, an ash, an asparagus fern, an aster, an astilbe, an Australia tree fern, an azalea, a baby's breath, a bachelor's button, a bald cypress, a balloon flower, a bamboo palm, a banana shrub, a barberry, a bee balm, a begonia, a bellflower, a bergamot, a bird-of-paradise, a bishop's flower, a black gum, a black-eyed Susan, a blanket flower, a blazing star, a blue lace flower, a blue Pacific juniper, a blue throatwort, a bluebeard, a bougainvillea, a boxwood, a butterfly bush, a bush lantana, a butcher's broom, a buttercup, a Bradford pear, a butterfly weed, a caladium, a calla lily, a Canary Island pine, a Cape jasmine, a carnation, a Caroline Jessamine, a cast iron plant, a century plant, a chalcus, a chestnut, a chestnut oak, a Chinese anise, a Chinese elm, a Chinese fan palm, a Chinese holly, a Chinese juniper, a Christmas palm, a chrysanthemum, an ornamental citrus, a cleyera, a climbing lily, a coastal leucothoe, a cock's comb, a coleus, a columbine, a coneflower, a Confederate jasmine, a copperleaf, a coral bells, a coreopsis, a cosmos, a cotoneaster, a cranberry cotoneaster, a crape myrtle, a creeping juniper, a croton, a daffodil, a dahlia, a daylily, a delphinium, a deutzia, a dianthus, a dracaena, a drake elm, a drooping leucothoe, a dusty miller, an Eastern cottonwood, an Eastern red cedar, an Eastern white pine, an elm, an English ivy, an escallonia, an eucalyptus, an euonymus, an European fan palm, a false bird of Paradise, a false cypress, a false saffron, a false spirea, a fatshedera, a ficus, a mini ficus, a fiddleleaf ficus, a fir, a balsam fir, a Fraser fir, a white fir, a firethorn, a Formosa firethorn, a scarlet firethorn, a fishtail palm, a flame lily, a flame maple, a fleabane, a Florida anise, a flowering dogwood, a forsythia, a border forsythia, a Fortune's osmanthus, a fountain grass, a four o'clock, a foxglove, a Fraser's photinia, a freesia, a gaillardia, a gallberry, a gardenia, a gazania, a geranium, a gerbera daisy, a ginkgo, a gladiolus, a globe amaranth, a gloriosa daisy, a gloriosa lily, a glory lily, a glossy abelia, a glossy privet, a gold-dust plant, a golden everlasting, a goldenrod, a heavenly bamboo, a hibiscus, a hickory, a Hinoki cypress, a holly, an honesty, a honeysuckle, a hosta, a hyacinth, a hydrangea, an impatiens, an Indian hawthorn, an inkberry, an iris, an Italian cypress, an ixora, a Jack pine, a Japanese aralia, a Japanese barberry, a Japanese camellia, a Japanese holly, a Japanese honeysuckle, a Japanese maple, a Japanese painted fern, a Japanese privet, a Japanese spirea, a Japanese star jasmine, a Japanese thistle, a Japanese viburnum, a jasmine, a juniper, a Kousa (Chinese) dogwood, a lady palm, a laurel oak, a Lawson's cypress, a leatherleaf fern, a lemon bottlebrush, a lemon scented gum, a Leyland cypress, a liatris, a ligustrum, a lily, a lily of the Incas, a lily turf, a liriope, a lisianthus, a littleleaf boxwood, a live oak, a lobelia, a loblolly pine, a lobster claw, a lodgepole pine, a longleaf pine, a loquat, a love-in-a-mist, a love-lies-bleeding, a lupine, a magnolia, a mahogany, a mahonia, a Manila palm, a maple, a marigold, a Mexican fan palm, a Mexican heather, a mondo grass, a money plant, a moneywort, a moss rose, a moth orchid, a myrtle, a nana-dwarf juniper, a nandina, a narcissus, a Natal palm, a Nellie Stevens holly, a no-azami, a Norfolk island pine, an oak, an oak-leaf hydrangea, an old-fashioned weigela, an oleander, an orange jasmine, an orchid tree, an Oriental arborvitae, an osmanthus, a pachysandra, a cat palm, a parlor palm, a pigmy date palm, a pampas grass, a pansy, a Parson's juniper, a pentas, a peony, a common periwinkle, a Madagascar periwinkle, a Persian buttercup, a Persian violet, a petunia, a philodendron, a phlox, a pin oak, a pincushion flower, a pine, a pineapple guava, a pinks, a pinwheel jasmine, a pittosporum, a plumbago, a podocarpus, a portulaca, a pot marigold, a prairie gentian, a primrose, a primrose jasmine, a princes flower, a privet, a purple anise, a pyracnatha, a Queen Anne's lace, a queen palm, a red buckeye, a red maple, a red oak, a red-hot poker, a redbud, a rhaphiolepsis, a river birch, a rose, a rose of China, a rose of Sharon, a rosemary, a ruscus, a Russian olive, a safflower, a sage, a sago palm, a salvia, a sandankwa virburnum, a sasanqua camellia, a saucer magnolia, a Savannah holly, a savin juniper, a Sawara cypress, a schefflera, a Scotch heather, a sea lavender, a sedum, a Shasta daisy, a shining jasmine, a shore juniper, a Shumard oak, a Siberian squill, a silver dollar, a silver dollar tree, a silver maple, a slash pine, a small-leaf jasmine, a snapdragon, a Society garlic, a Southern magnolia, a Southern red cedar, a spiderwort, a spiraea, a spiral flag, a St. John's wort, a star anise, a star jasmine, a statice, a strawberry guava, a strawflower, a sugar maple, a summer lilac, a sunflower, a sweet gum, a sweet tea, a sweet William, a sweetpea, a sweetspire, a sycamore, a tabebuia, a tea tree, a ternstroemia, a Texas sage, a trailing lantana, a tree fern, a tulip, a tulip tree, a Van Houtte spiraea, a variegated Chinese privet, a verbena, a viburnum, a Vicaryi privet, a vinca, a Washington fan palm, a water oak, a wax myrtle, a wedelia, a weeping bottlebrush, a weeping fig, a weeping podocarpus, an old-fashioned weigeia, a willow, a willow oak, a weeping willow, a wind flower, a windmill plant, a winter jasmine, a wintercreeper, a wintergreen barberry, a wisteria, a xylosma, a yarrow, a yaupon holly, or a zinnia.

In some embodiments, the essential oil is applied to one or more plants of the Solanaceae family. In some embodiments, the essential oil is applied to a package of plants from the Solanaceae family. In some embodiments, the essential oil is applied to an acnistus, a belladonna, a bouchetia, a browallia, a brugmansia, a raintree, a calibrachoa, a pepper, a Jessamine, a five eyes, a cyphomandra, a jimsonweed, a duboisia, a fabiana, a goetzea, a hunzikeria, a henbane, an iochroma, a jaborosa, a false holly, leucophysalis, a lyciathes, a desert-thorn, a mandrake, a margaranthus, a nectouxia, a nicandra, a tobacco, a cupflower, an aiea, an oryctes, a petunia, a groundcherry, a quincula, a salpichroa, a salpiglossis, a schizanthus, a scopolia, a solandra, a nightshade, a streptosolen, or a withania.

In some embodiments, the fungi is from the genus Botryotinia. Fungi from the Botryotinia genus include the species Botryotinia fuckeliana, Botrytis cinerea, Botryotinia convoluta, Botryotinia polyblastis, Botrytis allii, and Botrytis fabae. In some embodiments, the fungi is from the species Botrytis cinerea. In some embodiments, the fungi is from the genus Streptomyces. Fungi from the Streptomyces genus include the species Streptomyces globisorus, Streptomyces scabiei, Streptomyces acidiscabies, Streptomyces europaeiscabiei, Streptomyces luridiscabiei, Streptomyces niveiscabiei, Streptomyces puniciscabiei, Streptomyces reticuliscabiei, Streptomyces stelliscabiei, Streptomyces turgidiscabies, or Streptomyces ipomoeae. In some embodiments, the fungi is from the species Streptomyces globisorus. In some embodiments, the fungi is from the genus Penicillium. Fungi from the Penicillium genus include the species Penicillium allii, Penicillium digitatum, Penicillium expansum, and Penicillium italicum. In some embodiments, the fungi is from the species Penicillium italicium. In some embodiments, the fungi is from the genus Alternaria. Fungi from the Alternaria genus include the species Alternaria alternata, Alternaria brassicae, Alternaria conjuncta, Alternaria cucumerina, Alternaria dauci, Alternaria infectoria, Alternaria longipes, Alternaria radicina, and Alternaria solani. In some embodiments, the fungi is from the species Alternaria alternata. In some embodiments, the fungi is from the genus Colletotrichum. Fungi from the Colletotrichum genus include the species Colletotrichum acutatum, Colletotrichum agaves, Colletotrichum arachidis, Colletotrichum capsici, Colletotrichum cereale, Colletotrichum coccodes, Colletotrichum crassipes, Colletotrichum dematium, Colletotrichum derridis, Colletotrichum destructivum, Colletotrichum fragariae, Colletotrichum gloeosporioides, Colletotrichum gossypii, Colletotrichum graminicola, Colletotrichum higginsianum, Colletotrichum kahawae, Colletotrichum lindemuthianum, Colletotrichum lini, Colletotrichum mangenotii, Colletotrichum musae, Colletotrichum nigrum, Colletotrichum orbicularae, Colletotrichum pisi, Colletotrichum sublineolum, Colletotrichum trichellum, Colletotrichum trifoli, Colletotrichum truncatem, and Colletotrichum viniferum. In some embodiments, the fungi is from the species Colletotrichum coccoides. In some embodiments, the fungi is form the genus Rhizopus. Fungi from the Rhizopus genus include the species Rhizopus arrhizus, Rhizopus artocarpi, Rhizopus nigricans, and Rhizopus stolonifer. In some embodiments, the fungi is from the species Rhizopus stolonifer.

In some embodiments, the essential oil causes a direct fungitoxic effect on the fungus that is less than the total antibiotic activity. In some embodiments, the direct fungitoxic effect of the essential oil on the fungus as compared to the total antibiotic activity is less than 50%, less than 45%, less than 40%, less than 35%, less than 30%, less than 25%, less than 20%, less than 19%, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2%, or less than 1%. In some embodiments, the direct fungitoxic effect of the essential oil on the fungus as compared to the total antibiotic activity is less than 50%. In some embodiments, the direct fungitoxic effect of the essential oil on the fungus as compared to the total antibiotic activity is less than 30%. In some embodiments, the direct fungitoxic effect of the essential oil on the fungus as compared to the total antibiotic activity is less than 15%.

In some embodiments, the plant resists disease by fungal infection after application for at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20 days, at least 21 days, at least 22 days, at least 23 days, at least 24 days, at least 25 days, at least 26 days, at least 27 days, at least 28 days, at least 29 days, at least 30 days, at least 31 days, at least two months, at least three months, at least four months, at least five months, at least six months, at least seven months, at least eight months, at least nine months, at least ten months, at least eleven months, or at least one year.

In some embodiments, the plant package is a bag, a crate, a hamper, a basket, a carton, a bulk bin, a palletized container, a flat, a fiberboard container, a mesh bag, a plastic bag, a paper bag, a rigid plastic container, a plastic tray, or a clamshell.

In some embodiments, the plant package contains one or more plants. In some embodiments, the number of plants in the plant package is at least 1, at least 2, at least 5, at least 8, at least 10, at least 25, at least 50, at least 75, at least 100, at least 125, at least 150, at least 175, at least 200, at least 225, at least 250, at least 275, at least 300, at least 400, at least 500, at least 600, at least 700, at least 800, at least 900, or at least 1000.

In some embodiments, the plant package is stored, after application of the essential oil, at a temperature less than 1° C., less than 2° C., less than 3° C., less than 4° C., less than 5° C., less than 6° C., less than 7° C., less than 8° C., less than 9° C., less than 10° C., less than 11° C., less than 12° C., less than 13° C., less than 14° C., less than 15° C., less than 16° C., less than 17° C., less than 18° C., less than 19° C., less than 20° C., less than 21° C., less than 22° C., less than 23° C., less than 24° C., less than 25° C., or less than 26° C.

In some embodiments, the plant package is stored, after application of the essential oil, for at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20 days, at least 21 days, at least 22 days, at least 23 days, at least 24 days, at least 25 days, at least 26 days, at least 27 days, at least 28 days, at least 29 days, at least 30 days, at least 31 days, at least two months, at least three months, at least four months, at least five months, at least six months, at least seven months, at least eight months, at least nine months, at least ten months, at least eleven months, or at least one year.

In some embodiments, the present invention also provides a composition to elicit resistance in a plant to disease by fungal infection, wherein the composition comprises a solution or an atomized spray, and wherein the solution or the atomized spray comprises an essential oil in combination with 2-hydroxy acetophenone or a derivative of acetophenone.

It has been found that exposure of cineole induces the production of compounds in tomato skin which are responsible for the observed cineole-induced resistance to fungal infection. One of these substances is 2-hydroxy acetophenone. It has been found that 2-hydroxy acetophenone and derivatives of acetophenone can inhibit the growth of the fungus Botrytis cinerea.

In some embodiments, the composition comprises an essential oil and 2′-hydroxyacetophenone or a derivative of acetophenone. In some embodiments, the derivative of acetophenone is 3′-hydroxyacetophenone, 4′-hydroxyacetophenone, 2′,3′-dihydroxyphenone, 2′,4′-dihydroxyphenone, 2′,6′-dihydroxyphenone, 3′,4′-dihydroxyphenone, 3′,5′-dihydroxyphenone, 2′,3′,4′-trihydroxyphenone, 2′,3′,5′-trihydroxyphenone, 2′,3′,6′-trihydroxyphenone, 3′,4′,5′-trihydroxyphenone, 3′,4′,6′-trihydroxyphenone, 2′-methoxyacetophenone, 3′-methoxyacetophenone, 4′-methoxyacetophenone, 2′-hydroxy-3′-methoxyphenone, 2′-hydroxy-3′-methoxyphenone, 2′-hydroxy-6′-methoxyphenone, 3′-hydroxy-4′-methoxyphenone, or 3′-hydroxy-5′-methoxyphenone. In some embodiments, the composition comprises an essential oil and 2′-hydroxyacetophenone.

In some embodiments, the composition comprises (A) an essential oil and (B) acetophenone or a derivative of acetophenone in a weight ratio of (A):(B) between 1000:1 to 1:1000, between 1000:1 to 1:750, between 1000:1 to 1:500, between 1000:1 to 1:100, between 1000:1 to 1:50, between 1000:1 to 1:10, between 1000:1 to 1:5, between 1000:1 to 1:1, between 750:1 to 1:750, between 750:1 to 1:500, between 750:1 to 1:100, between 750:1 to 1:50, between 750:1 to 1:10, between 750:1 to 1:5, between 750:1 to 1:1, between 500:1 to 1:500, between 500:1 to 1:100, between 500:1 to 1:50, between 500:1 to 1:10, between 500:1 to 1:5, between 500:1 to 1:1, between 100:1 to 1:100, between 100:1 to 1:50, between 100:1 to 1:10, between 100:1 to 1:5, between 100:1 to 1:1, between 50:1 to 50:1, between 50:1 to 10:1, between 50:1 to 1:5, between 50:1 to 1:1, between 10:1 to 1:5, between 10:1 to 1:1, or between 5:1 to 1:1.

The following examples are illustrative and non-limiting, of the products and methods described herein. Suitable modifications and adaptations of the variety of conditions, formulations, and other parameters normally encountered in the field and which are obvious to those skilled in the art in view of this disclosure are within the spirit and scope of the invention.

### EXAMPLES

### Example 1

### Effect of Essential Oil on Infected and Uninfected Tomatoes

Healthy tomato fruits were collected from plants free of treatment with pesticides or any other control agent. According to the Jaramillo scale (Jaramillo, J., et al., “Technical Manual: Good Agricultural Practices in the Production of Tomato Under Protected Conditions,” Food and Agricultural Organization of the United Nations (2007)) the tomatoes were at level 3 of maturation. The tomatoes were superficially disinfected and were put in plastic boxes (each box: 10 cm×17 cm×33 cm). There were eight (8) tomatoes per plastic box.

Three sets (two boxes per set) of boxes with tomatoes were prepared as follows:

Set No. 1:

(A) Each tomato was punctured multiple times with a sterile needle. A small agar disk with Botrytis cinerea (1×10⁶ conidia per disk) was put over each puncture.

(B) 2.805 mL of liquid pure eucalyptus oil in a Petri dish (for a final vapor concentration of 500 ppm once the eucalyptus oil has completely evaporated, since there were no remains at all of liquid eucalyptus oil) was put inside the box 48 hours before infection with Botrytis cinerea, 24 hours before the infection, at time 0 (time of the infection), and 24 hours after the infection. After application, the lid was placed on the box.

Set No. 2:

(A) Tomatoes were not infected.

(B) 2.805 mL of sterile water in a Petri dish was put inside the box. The lid was placed on the box.

Set No. 3:

(A) Each tomato was punctured multiple times with a sterile needle. A small agar disk with Botrytis cinerea (1×10⁶ conidia per disk) was put over each puncture.

(B) 2.805 ml of sterile water in a Petri dish was put inside the box 48 hours before infection with Botrytis cinerea, 24 hours before the infection, at time 0 (time of the infection), and 24 hours after the infection. After application, the lid was placed on the box.

After 13 days of the infection all tomatoes were examined. The results are shown in TABLE 1.

TABLE 1

| | Number of diseased | Percentage disease free |
|---|---|---|
| Set No. | tomatoes | (Healthy tomatoes) |
| 1 | 1 out of 16 | 93.75% |
| 2 | 0 | 100% |
| 3 | 16 out of 16 | 0% |

When tomatoes of Set No. 1 were examined after the above described experiments, it was observed that the punctures had healed and that the fungus had not colonized the tomato tissues—no disease or decay was observed. The internal and external tissues of the tomato were healthy and without any alterations in color, brightness, odor, or texture.

When the eucalyptus oil used in the experiments was analyzed by gas chromatography, the main component (greater than 80%) was 1-8 cineole.

To discard a direct fungitoxic effect on Botrytis cinerea by eucalyptus oil, the following experiment was made:

1. Botrytis cinerea spores were grown in an appropriate culture medium enriched with eucalyptus oil. No growth inhibition of Botrytis cinerea fungus was observed.

2. An open Petri dish with appropriate culture medium inoculated with Botrytis cinerea spores was put in empty plastic boxes (each box: 10 cm×17 cm×33 cm). The lid was placed on the box.

2.805 mL of liquid pure eucalyptus oil in a Petri dish (for a final vapor concentration of 500 ppm once the eucalyptus oil has completely evaporated) was put inside the box 48 hours before infection with Botrytis cinerea, 24 hours before the infection, at time 0 (time of the infection), and 24 hours after the infection. No growth inhibition of Botrytis cinerea fungus was observed.

The results of the experiments described above show that there is no direct fungitoxic effect of the essential oil, eucalyptus oil, on Botrytis cinerea. Although no direct fungitoxic effect was present, tomatoes, upon exposure to an environment saturated with 500 ppm eucalyptus oil, became resistant to fungal infection after contamination with Botrytis cinerea conidia.

### Example 2

### Effect of 0.25 mL, 0.50 mL, and 1.0 mL Treatments of Eucalyptus Oil on Pears

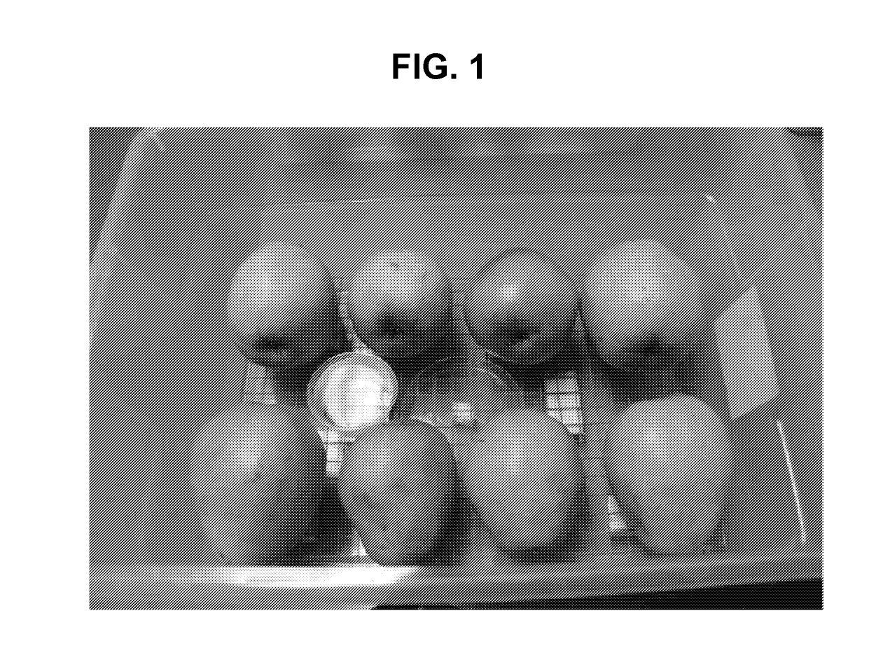

Tests were performed on pears (species Pyrus communis, cultivar ‘Ranier’) in a Bio Research Field Station located in Fresno, Calif. Twenty clear, plastic containers (each box: 21 cm×34.5 cm×12.2 cm), were prepared by gluing open side up, the bottom half of a single Petri dish (100 mm×15 mm) to the center of each box. A typical test container is shown in FIG. 1. Four blocks (1.95 cm high), were installed around the Petri dishes to support a steel mesh screen cut to the inside area of the plastic container. A sponge measuring approximately 1.3 cm³, was glued to the center of each Petri dish for use as an absorbent material onto which the eucalyptus oil (Eucalyptol, ≧99%, Sigma Aldrich, St. Louis, Mo.) was applied at a rate of 0.25 mL (for a final vapor concentration of 30 ppm after evaporation of the eucalyptus oil), 0.5 mL (for a final vapor concentration of 60 ppm after evaporation of the eucalyptus oil), or 1.0 mL (for a final vapor concentration of 120 ppm after evaporation of the eucalyptus oil) per container. Eight, near fully ripe, organically grown pears were surface sterilized in 1% sodium hypochlorite for 1 minute and uniformly placed on the steel screen in a 2×4 pattern. An application of the test materials was made on day 0 using a 2 mL pipette to apply the test products to the sponge material according to the test protocol. A conidial suspension (Botrytis cinerea), adjusted to an approximate concentration of 290,000 conidia/mL, was prepared 1 hour prior to the test product application. Using a fine, flame-sterilized needle, 4 wounds approximately 1 mm deep were made to the top of each pear in the four test containers with the pears in the fifth container being the absolute untreated control group. A single drop of inoculum (50 μL) was placed directly on each wounded area. The boxes were then sealed with a single layer of clear, plastic film, then with a plastic lid. The containers were placed on a folding table in a randomized complete block design under room temperature conditions averaging 21.1° C.

Evaluations were conducted 3, 6, 9, 12, 15, and 18 days after application of the test materials. The fitted lid was removed from each box and the rate of fruit breakdown (cm), Botrytis sporulation incidence, and disease severity (%) was determined without removing the plastic films. On day 3, only a slight breakdown of the fruit was occurring around the wound area of each inoculated fruit. On day 6, measurement of the necrotic portion of each fruit revealed significant (p=0.05) differences in the size of the necrotic area of each fruit between the untreated control plots and the plots treated with eucalyptus oil. Moreover, a distinct positive rate relationship was established between the low, medium, and high rates of the test product. By day 9, there remained a significant difference in breakdown between the untreated control and the treatments; however at this time, there were no statistical difference in breakdown within the pears treated with 0.25 mL, 0.50 mL, and 1.0 mL of eucalyptus oil (Table 2).

TABLE 2
Percentage of Necrotic Portion of the Pear After 3, 6, and 9 Days

| Treatment | Day 3 | Day 6 | Day 9 |
|---|---|---|---|
| 0.25 mL treatment | 0.0 | 2.70 | 4.72 |
| 0.50 mL treatment | 0.0 | 3.03 | 4.97 |
| 1.0 mL treatment | 0.0 | 2.49 | 4.52 |
| Control (no fungus) | 0.0 | 0.03 | 0.00 |
| Control (no treatment) | 0.0 | 3.48 | 5.98 |

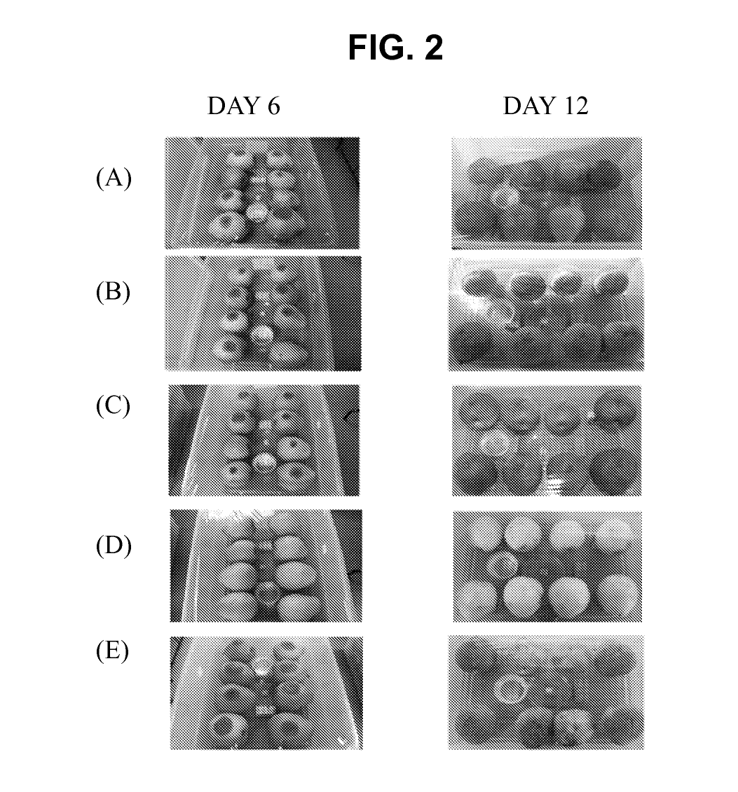

After nine days, aerial mycelium was visible throughout the surface area of the necrotic fruit surfaces. Evaluation of disease severity based on % sporulation of the infected area was conducted for each fruit after this point. Photographs of the pears at day 6 and day 12 are shown in FIG. 2. An evaluation conducted on day 12 revealed significant differences in disease severity amongst the treatments, with the 0.5 and 1.0 mL containers exhibiting significantly less disease than the containers with the 0.25 mL treatment and the untreated control. By day 15, the 1.0 mL treatment showed significantly less disease than all other treatments except the absolute untreated control (un-inoculated). By day 18, disease severity in the untreated control plots was averaging 73%, significantly more than the 0.25 and 0.50 mL treatments, which averaged 60% and 57%, respectively. The most efficacious treatment was the 1.0 mL which exhibited a 42% disease rate as shown in Table 3.

TABLE 3
Percentage of Necrotic Portion of
the Pear After 12, 15, and 18 Days

| Treatment | Day 12 | Day 15 | Day 18 |
|---|---|---|---|
| 0.25 mL treatment | 19.89 | 39.11 | 60.11 |
| 0.50 mL treatment | 8.78 | 31.00 | 57.05 |
| 1.0 mL treatment | 7.54 | 27.22 | 42.34 |
| Control (no fungus) | 0.06 | 0.09 | 0.22 |
| Control (no treatment) | 23.25 | 49.84 | 72.66 |

### Example 3

### Effect of 0.25 mL and 1.0 mL Treatments of Eucalyptus Oil on Strawberries

Healthy strawberries were collected from plants free of treatment with systemic fungicides for the treatment of Botrytis cinerea at least 15 days before harvest. The strawberries were selected at level 3 of maturation (between 10 and 30% of the surface of the fruit is pale yellow, pink, red, or a combination thereof). The strawberries were superficially disinfected and were put in plastic closed boxes (volume of 5 liters) containing two layers of fruit equivalent to 120 strawberries per plastic box.

Four sets (four boxes per set) of boxes with strawberries were prepared as follows:

Set No. 1:

(A) Each strawberry was punctured multiple times with a sterile needle. A small agar disk with Botrytis cinerea (1×10⁶ conidia per disk) was put over each puncture.

(B) 0.25 mL of liquid eucalyptus oil (Eucalyptol, ≧99%, Sigma Aldrich, St. Louis, Mo.) (for a final vapor concentration of 50 ppm after evaporation of the eucalyptus oil) was deposited in small cryovials located within the plastic box for 6 hours after infection, 12 hours after infection, and 24 hours after infection. The lid was placed on the box.

Set No. 2:

(A) Each strawberry was punctured multiple times with a sterile needle. A small agar disk with Botrytis cinerea (1×10⁶ conidia per disk) was put over each puncture.

(B) 1.0 mL of liquid eucalyptus oil (Eucalyptol, ≧99%, Sigma Aldrich, St. Louis, Mo.) (for a final vapor concentration of 200 ppm after evaporation of the eucalyptus oil) was deposited in small cryovials located within the plastic box for 6 hours after infection, 12 hours after infection, and 24 hours after infection. The lid was placed on the box.

Set No. 3:

(A) Strawberries were not infected.

(B) Sterile water in small cryovials was put inside the box. The lid was placed on the box.

Set No. 4:

(A) Each strawberry was punctured multiple times with a sterile needle. A small agar disk with Botrytis cinerea (1×10⁶ conidia per disk) was put over each puncture.

(B) Sterile water in small cryovials was put inside the box. The lid was placed on the box.

After the treatments were applied, the plastic containers were incubated for 4 days under ambient conditions at a temperature of 25° C.

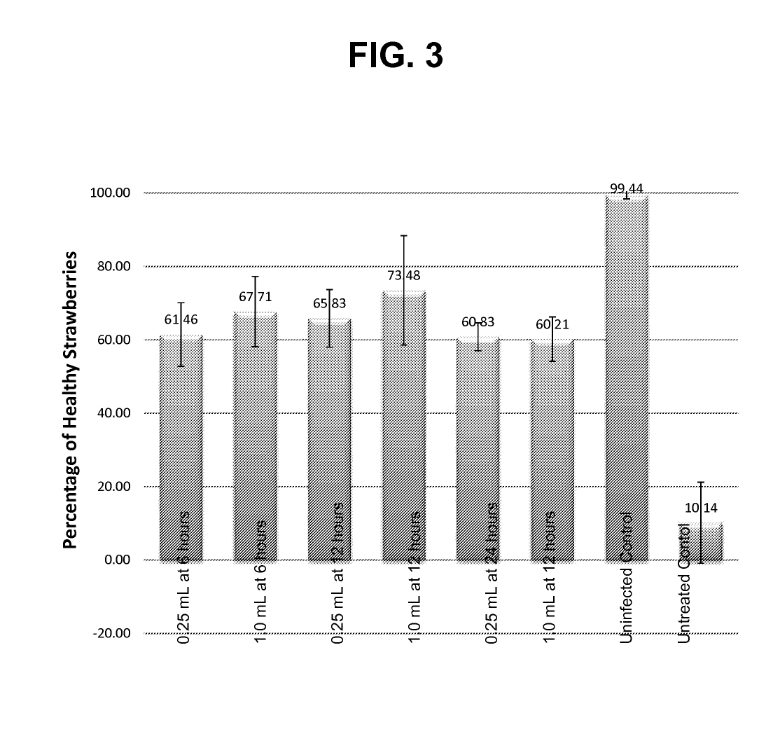

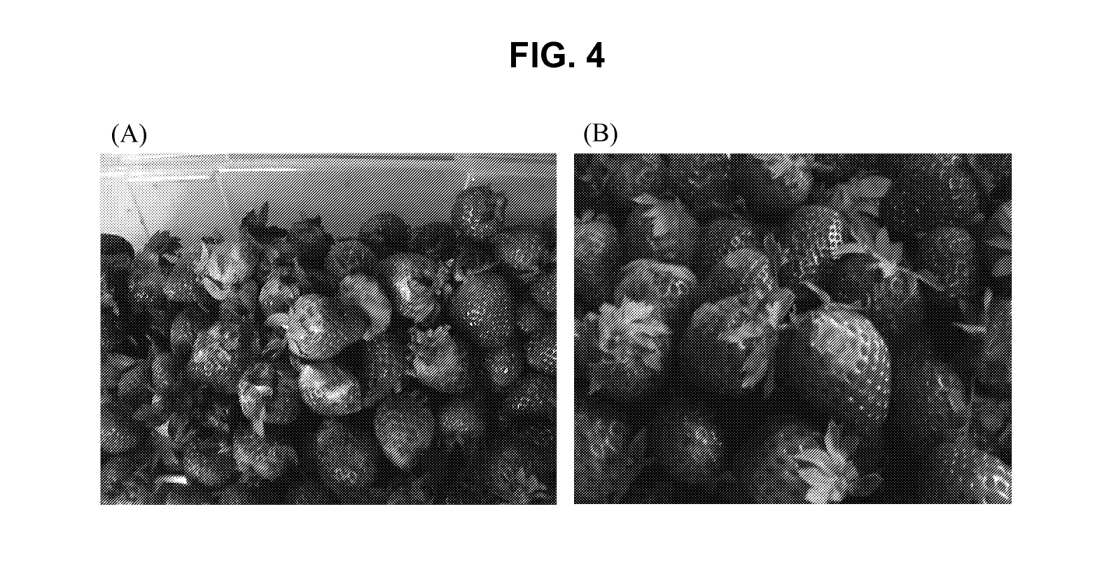

After four days, 0.25 mL treatment of the infected strawberries with a contact time of 6 hours, 12 hours, and 24 hours prevented the appearance of disease by 61.46%, 65.83%, and 60.83%, respectively. After four days, 1.0 mL treatments of the infected strawberries with a contact time of 6 hours, 12 hours, and 24 hours prevented the appearance of disease by 67.71%, 73.48%, and 60.21%, respectively. After four days, the untreated control showed only 10.14% of healthy strawberries. The results are shown in FIG. 3. FIG. 4 displays the increased amount of soft rot and discoloration of strawberries exposed for 24 hours to 0.25 mL of eucalyptus oil compared to 1.0 mL of eucalyptus oil.

### Example 4

### Effect of 0.25 mL, 0.50, and 1.0 mL Treatments of Eucalyptus Oil on Strawberries Stored at 4° C. and 25° C.

Healthy strawberries were collected from plants free of treatment with systemic fungicides for the treatment of Botrytis cinerea at least 15 days before harvest. The strawberries were selected at level 3 of maturation (between 10 and 30% of the surface of the fruit is pale yellow, pink, red, or a combination thereof). The strawberries were superficially disinfected and were put in plastic closed boxes (volume of 5 liters) containing two layers of fruit equivalent to 120 strawberries per plastic boxes.

Five sets of containers with strawberries were prepared as follows:

Set No. 1 (two boxes):

(A) Each strawberry was punctured multiple times with a sterile needle. A small agar disk with Botrytis cinerea (1×10⁶ conidia per disk) was put over each puncture.

(B) 0.25 mL of liquid eucalyptus oil (Eucalyptol, ≧99%, Sigma Aldrich, St. Louis, Mo.) (for a final vapor concentration of 50 ppm after evaporation of the eucalyptus oil) was deposited in small cryovials located within the plastic box. The lids were placed on the boxes. One box was stored at 4° C. and one box was stored at 25° C.

Set No. 2 (two boxes):

(A) Each strawberry was punctured multiple times with a sterile needle. A small agar disk with Botrytis cinerea (1×10⁶ conidia per disk) was put over each puncture.

(B) 0.50 mL of liquid eucalyptus oil (Eucalyptol, ≧99%, Sigma Aldrich, St. Louis, Mo.) (for a final vapor concentration of 100 ppm after evaporation of the eucalyptus oil) was deposited in small cryovials located within the plastic box. The lids were placed on the boxes. One box was stored at 4° C. and one box was stored at 25° C.

Set No. 3 (two boxes):

(A) Each strawberry was punctured multiple times with a sterile needle. A small agar disk with Botrytis cinerea (1×10⁶ conidia per disk) was put over each puncture.

(B) 1.0 mL of liquid eucalyptus oil (Eucalyptol, ≧99%, Sigma Aldrich, St. Louis, Mo.) (for a final vapor concentration of 200 ppm after evaporation of the eucalyptus oil) was deposited in small cryovials located within the plastic box. The lids were placed on the boxes. One box was stored at 4° C. and one box was stored at 25° C.

Set No. 4 (two boxes):

(A) Strawberries were not infected.

(B) Sterile water in small cryovials was put inside the box. The lids were placed on the boxes. One box was stored at 4° C. and one box was stored at 25° C.

Set No. 5 (two boxes):

(A) Each strawberry was punctured multiple times with a sterile needle. A small agar disk with Botrytis cinerea (1×10⁶ conidia per disk) was put over each puncture.

(B) Sterile water in small cryovials was put inside the plastic container.

The lids were placed on the boxes. One box was stored at 4° C. and one box was stored at 25° C.

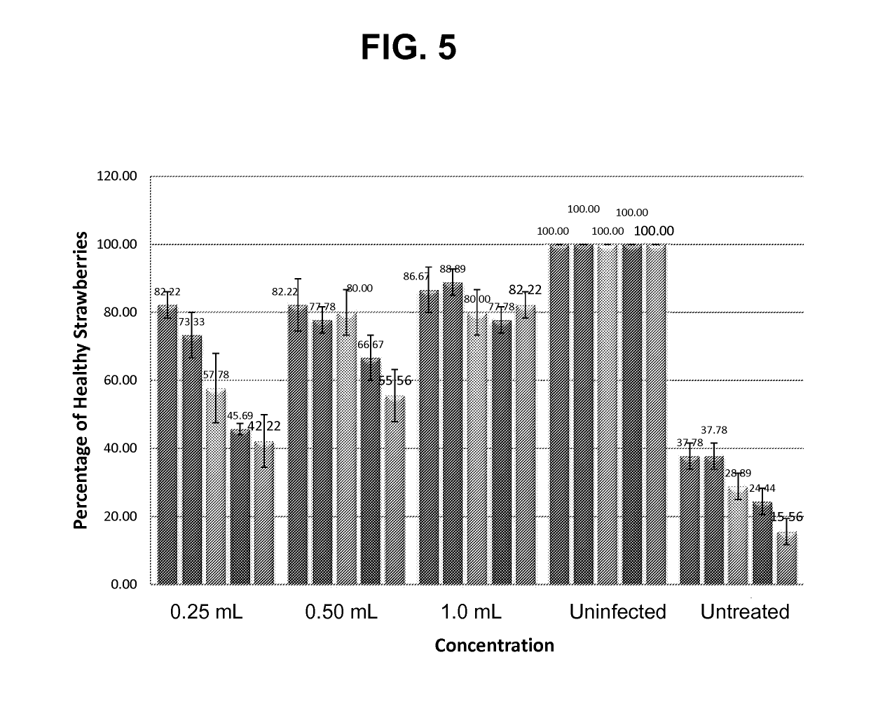

The percentage of healthy strawberries for each set of boxes stored at 4° C. was determined at days 3, 6, 9, 12, and 15 as shown in FIG. 5. After 15 days, the 1.0 mL treatment showed 82.2% of healthy strawberries, followed by the treatment with 0.5 mL with 55.5%, and the treatment with 0.25 mL with 42.2%. The untreated control contained 15.56% healthy strawberries after 15 days.

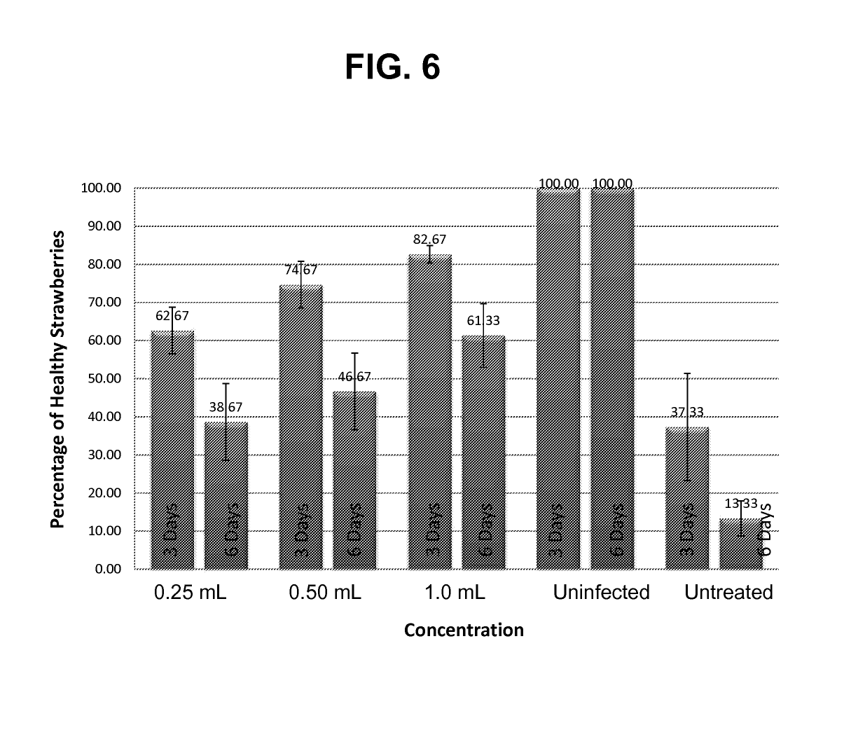

The percentage of healthy strawberries for each set of boxes stored at 25° C. was determined at days 3 and 6 as shown in FIG. 6. After 6 days, the 1.0 mL treatment showed 61.33% of healthy strawberries, followed by the treatment with 0.5 mL containing 46.67%, and the treatment with 0.25 mL containing 38.67%. The untreated control contained 13.33% healthy strawberries after 6 days.

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All of the various aspects, embodiments, and options described herein can be combined in any and all variations.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A method to elicit resistance in a plant to disease by fungal infection, wherein the method comprises exposing at least one plant to an essential oil vapor, and wherein the essential oil contains cineole.

2. The method of claim 1, wherein the concentration of the vapor derived from the essential oil is between about 1 ppm and about 1000 ppm.

3. The method of claim 1, wherein the concentration of the vapor derived from the essential oil is between about 5 ppm and about 750 ppm.

4. The method of claim 1, wherein the concentration of the vapor derived from the essential oil is between about 100 ppm and about 600 ppm.

5. The method of claim 1, wherein the essential oil is eucalyptus oil.

6. The method of claim 1, wherein the fungus is selected from the group consisting of Botryotinia, Streptomyces, and Penicillium.

7. The method of claim 1, wherein the fungus is from the species Botrytis cinerea.

8. The method of claim 1, wherein the plant is selected from the group consisting of a potato, a tomato, an aubergine, a chili pepper, a bell pepper, a tomatillo, a groundcherry, a cape gooseberry, a tobacco, an apple, a pear, a quince, a peach, a plum, a cherry, a strawberry, a grape, an almond, an apricot, a blackberry, a raspberry, a rose, a petunia, a browallia, and a lycianthes.

9. The method of claim 1, wherein the plant is selected from the group consisting of a tomato, a strawberry, and a pear.

10. The method of claim 1, wherein the plant is a tomato.

11. The method of claim 1, wherein the plant is a strawberry.

12. The method of claim 1, wherein the plant is a pear.

13. The method of claim 1, wherein less than about 50% of total antibiotic activity on the fungus derives from a direct fungitoxic effect of the essential oil or the essential oil vapor on the fungus.

14. The method of claim 1, wherein less than about 30% of total antibiotic activity on the fungus derives from a direct fungitoxic effect of the essential oil or the essential oil vapor on the fungus.

15. The method of claim 1, wherein less than about 15% of total antibiotic activity on the fungus derives from a direct fungitoxic effect of the essential oil or the essential oil vapor on the fungus.

16. A plant package in combination with an essential oil containing cineole for eliciting resistance in a plant to disease by fungal infection, wherein the plant is susceptible to infection by a fungus, wherein the essential oil turns into a vapor form in the environment surrounding the plant.

17. The package of claim 16, wherein the concentration of the vapor derived from the essential oil is between about 1 ppm and about 1000 ppm.

18. The package of claim 16, wherein the concentration of the vapor derived from the essential oil is between about 5 ppm and about 750 ppm.

19. The package of claim 16, wherein the concentration of the vapor derived from the essential oil is between about 100 ppm and about 600 ppm.

20. The package of claim 16, wherein the essential oil is eucalyptus oil.

21. The package of claim 16, wherein the fungus is selected from the group consisting of Botryotinia, Streptomyces, and Penicillium.

22. The package of claim 16, wherein the fungus is from the species Botrytis cinerea.

23. The package of claim 16, wherein the plant is selected from the group consisting of a potato, a tomato, an aubergine, a chili pepper, a bell pepper, a tomatillo, a groundcherry, a cape gooseberry, a tobacco, an apple, a pear, a quince, a peach, a plum, a cherry, a strawberry, a grape, an almond, an apricot, a blackberry, a raspberry, a rose, a petunia, a browallia, and a lycianthes.

24. The package of claim 16, wherein the plant is selected from the group consisting of a tomato, a strawberry, and a pear.

25. The package of claim 16, wherein the plant is a tomato.

26. The package of claim 16, wherein the plant is a strawberry.

27. The package of claim 16, wherein the plant is a pear.

28. The package of claim 16, wherein less than about 50% of total antibiotic activity on the fungus derives from a direct fungitoxic effect of the essential oil or the essential oil vapor on the fungus.

29. The package of claim 16, wherein less than about 30% of total antibiotic activity on the fungus derives from a direct fungitoxic effect of the essential oil or the essential oil vapor on the fungus.

30. The package of claim 16, wherein less than about 15% of total antibiotic activity on the fungus derives from a direct fungitoxic effect of the essential oil or the essential oil vapor on the fungus.

31. A composition to elicit resistance in a plant to disease by fungal infection, wherein the composition comprises a solution or an atomized spray, and wherein the solution or the atomized spray comprises an essential oil.

32. The composition of claim 31, wherein the concentration of the solution or the atomized spray is between about 1 ppm and about 1000 ppm.

33. The composition of claim 31, wherein the concentration of the solution or the atomized spray is between about 5 ppm and about 750 ppm.

34. The composition of claim 31, wherein the concentration of the solution or the atomized spray is between about 100 ppm and about 600 ppm.

35. The composition of claim 31, wherein the essential oil is eucalyptus oil.

36. The composition of claim 31, wherein the fungus is selected from the group consisting of Botryotinia, Streptomyces, and Penicillium.

37. The composition of claim 31, wherein the fungus is from the species Botrytis cinerea.

38. The composition of claim 31, wherein the plant is selected from the group consisting of a potato, a tomato, an aubergine, a chili pepper, a bell pepper, a tomatillo, a groundcherry, a cape gooseberry, a tobacco, an apple, a pear, a quince, a peach, a plum, a cherry, a strawberry, a grape, an almond, an apricot, a blackberry, a raspberry, a rose, a petunia, a browallia, and a lycianthes.

39. The composition of claim 31, wherein the plant is selected from the group consisting of a tomato, a strawberry, and a pear.

40. The composition of claim 31, wherein the plant is a tomato.

41. The composition of claim 31, wherein the plant is a strawberry.

42. The composition of claim 31, wherein the plant is a pear.

43. The composition of claim 31, wherein less than about 50% of total antibiotic activity on the fungus derives from a direct fungitoxic effect of the solution or the atomized spray on the fungus.

44. The composition of claim 31, wherein less than about 30% of total antibiotic activity on the fungus derives from a direct fungitoxic effect of the solution or the atomized spray on the fungus.

45. The composition of claim 31, wherein less than about 15% of total antibiotic activity on the fungus derives from a direct fungitoxic effect of the solution or the atomized spray on the fungus.
